(19) United States
(12) Patent Application Publication
(10) Pub. No.: US 2013/0194429 A1
(43) Pub. Date: Aug. 1, 2013

(54) MULTI-SCENE MONITORING SYSTEM AND METHOD FOR CONTROLLING THE SAME

(71) Applicant: Ching-Lin Wu, New Taipei City (TW)

(72) Inventor: Ching-Lin Wu, New Taipei City (TW)

(73) Assignee: AMROAD TECHNOLOGY, INC., New Taipei City (TW)

(21) Appl. No.: 13/363,377

(22) Filed: Feb. 1, 2012

(51) Int. Cl. H04N 7/18

(52) U.S. Cl. 348/159; 348/E07.085

(57) ABSTRACT

The present invention discloses a multi-scene monitoring system and a method for controlling the same. The surveillance system comprises an internal communication device, a warning module, a door end operating device, and at least one external shooting module; the internal communication device comprises a first data processing unit, an image receiving unit, an image display, an image switching unit, and a receiving end intercom module; the door end operating device comprises a second data processing unit, a driving unit, a door end shooting module, and a door end intercom module. The control method comprises the steps of: dynamic image streams taken by the door end shooting module being transmitted to the internal communication device through the second data processing unit; and a user operating the image switching unit to switch different shooting modules and obtain dynamic images with different scenes or angles.

### BACKGROUND OF THE INVENTION

1. Field of the Invention

The present invention relates to a multi-scene monitoring system and a method for controlling the same, and more particularly to a monitoring system having a plurality of shooting modules which can be randomly switched by a host to obtain dynamic images with different scenes or angles.

2. Description of the Prior Art

In this modern society, with the gradually rising life quality, living comfort and convenience, in particular, are indispensables. Therefore, human beings take advantage of the rapidly developed technology to create many inventions for further comforting and facilitating our daily life, and among others, outdoor communication devices would be one typical example. The most primitive outdoor communication devices only allowed for transmit audio messages, and a host cannot recognize the identity of a visitor by viewing the image. Therefore, an audio-type outdoor communication device is able to have great improvement space.

Then, there were inventors bringing up architecture of a video-audio outdoor communication device. Referring to FIG. 1A, the most primitive video-audio outdoor communication device A2 transmits images and audio messages with analog signals, and an internal communication device A1 is only permitted to transmit signals with one video-audio outdoor communication device A2. In this architecture, the internal communication device A1 is not allowed to switch the connection between several video-audio outdoor communication devices A2, and several internal communication devices A1 are not allowed to connect with the same video-audio outdoor communication device A2.

Then, referring to FIG. 1B, an improved video-audio outdoor communication device was developed and based on analog signals. In the above architecture, a telecommunication exchange device B3 is introduced and makes at least one internal communication device B1 connect with a plurality of video-audio outdoor communication devices B2a, B2b and B2c. This architecture allows a user to switch different video-audio outdoor communication devices B2a, B2b and B2c to reach the purpose of switching images with multiple shooting scenes or angles. As shown in FIG. 1c, a plurality of video-audio outdoor communication devices B2a, B2b and B2c can be set in different places and angles to reduce dead spaces of shooting and increase security. However, the shortcoming of the architecture is that the analog signal can easily be interfered and then produce noise. In addition, the installation of these devices requires a great amount of concrete wires which have to be dismantled or installed when repairing the devices or introducing new devices, which are works with cost, time and strength consuming.

After the coming of the digital era, a digital video-audio outdoor communication device is developed. As shown in FIG. 1D, that illustrates a conventional structure of a digital video-audio outdoor communication device. This architecture permits internal communication devices D1a, D1b and D1c of different users to connect with a video-audio outdoor communication device D2a and a plurality of shooting modules D2b and D2c through an internet D4, and any of the users can switch the connection of his internal communication device with the outdoor communication device D2a or the shooting modules D2b and D2c. If one user possesses a plurality of internal communication devices D1a and D1b, which can be connected to a telecommunication exchange device D3 first and then connected with the video-audio outdoor communication device D2a and the shooting modules D2b and D2c through the internet D4. In this architecture, digital signals can increase the stability of transmission, and the installation of the devices is very easy without altering the arrangement of concrete wires frequently, thus the structure improves the shortcoming of the conventional one with analog signals. However, when an internal communication device, such as D1a, is operated to switch the connection between the outdoor communication device D2a and the shooting modules D2b and D2c, the original connection has to be broken then the internal communication device D1a is permitted to connect with the other device. If the user merely wants to change the shooting angle, the conventional digital video-audio outdoor communication device can not achieve the purpose.

In view of this, it is necessary to provide an improved digital video-audio outdoor communication device, which permit the user to switch different shooting angles without disconnection so as to increase the home safety.

### SUMMARY OF THE INVENTION

In view of the above shortcomings of the prior art, the inventor of the present invention resorted to past experience, imagination, and creativity, performed experiments and researches repeatedly, and eventually devised the present invention—a multi-scene monitoring system and a method for controlling the same.

The first objective of the present invention is to provide a multi-scene monitoring system for decreasing the installing cost of the whole system, wherein the surveillance system transmits digital signals through an internet, and an internal communication device and a door end operating device only need to connect with the internet without installing concrete wires so as to save a lot of costs in installation and maintenance.

The second objective of the present invention is to provide a method for controlling the multi-scene monitoring system for a user to switch different shooting angles or scenes, wherein the user can drive an image switching unit of the internal communication device and then the internal communication device snatches dynamic images of a particular shooting module by an RTSP (Real Time Streaming Protocol) or a Multicast protocol so as to achieve the purpose of image switching.

The third objective of the present invention is to provide a method for controlling the multi-scene monitoring system for the user to switch different shooting angles or scenes, wherein the user can drive the image switching unit of the internal communication device, and a second data processing unit of a door end operating device sends an SIP (Session Initiation Protocol) reinvite command to a first data processing unit of the internal communication device and a processing unit of a particular shooting module simultaneously, and then the particular shooting module transmits image streams to the internal communication device so as to achieve the purpose of image switching.

The fourth objective of the present invention is to provide a method for controlling the multi-scene monitoring system for the user to switch different shooting angles or scenes, wherein the user can drive the image switching unit of the internal communication device, and the switch to the shooting modules is by means of multiple RTP (Real Time Transport Protocol) streaming so as to achieve the purpose of image switching.

The fifth objective of the present invention is to provide a method for controlling the multi-scene monitoring system for the user to switch different shooting angles or scenes, wherein the user can drive the image switching unit of the internal communication device, and then the internal communication device snatches a plurality of serial still images and combines the serial still images to be a dynamic image so as to achieve the purpose of image switching.

Consequently, the present invention provides a multi-scene monitoring system and a method for controlling the same, wherein the surveillance system comprises an internal communication device, a warning module, a door end operating device, and at least one external shooting module. The internal communication device is disposed indoors and comprises: a first data processing unit for integrating and transmitting image and audio data and operation information; an image receiving unit being connected with the first data processing unit and obtaining image streams from the first data processing unit; an image display being connected with the image receiving unit and displaying the image streams obtained from the image receiving unit; an image switching unit being connected with the first data processing unit and sending commands to switch different image streams; and a receiving end intercom module being connected with the first data processing unit and for a host to talk with a visitor. The warning module is disposed indoors and controlled by the first data processing unit to send out warning messages. The door end operating device is disposed outdoors and comprises: a second data processing unit for integrating image and audio data and transmitting the data to the first data processing unit through an internet; a driving unit being connected with the second data processing unit and provided for the visitor to activate the warning module; a door end shooting module comprising a third data processing unit and taking images of the visitor, wherein the images are transmitted to the second data processing unit by the third data processing unit; and a door end intercom module being connected with the second data processing unit and provided for the visitor to talk with the host. The external shooting module is disposed at a particular position outdoors and comprises a fourth data processing unit, wherein the images of the visitor taken by the external shooting module are transmitted to the internal communication device by the fourth data processing unit and displayed on the image display, and wherein the shooting angles of the external shooting module and the door end shooting module are different so as to decrease shooting dead spaces.

### BRIEF DESCRIPTION OF THE DRAWINGS

FIG. 1A illustrates an architectural diagram of a conventional analog signal type video-audio outdoor communication device;

FIG. 1B illustrates an architectural diagram of an improved conventional analog signal type video-audio outdoor communication device;

FIG. 1C illustrates a schematic diagram of various shooting angles;

FIG. 1D illustrates an architectural diagram of a conventional digital type video-audio outdoor communication device;

FIG. 2 illustrates an architectural diagram of a multi-scene monitoring system of the present invention;

FIG. 3 illustrates a flow chart for controlling the multi-scene monitoring system according to a first preferred embodiment of the present invention;

FIG. 4 illustrates a flow chart for controlling the multi-scene monitoring system according to a second preferred embodiment of the present invention;

FIG. 5 illustrates a flow chart for controlling the multi-scene monitoring system according to a third preferred embodiment of the present invention; and

FIG. 6 illustrates a flow chart for controlling the multi-scene monitoring system according to a fourth preferred embodiment of the present invention.

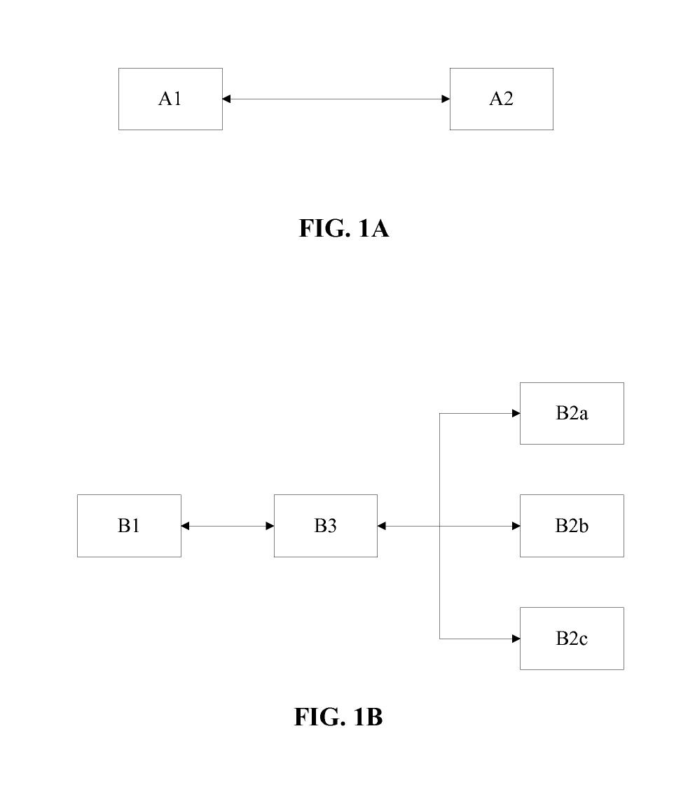

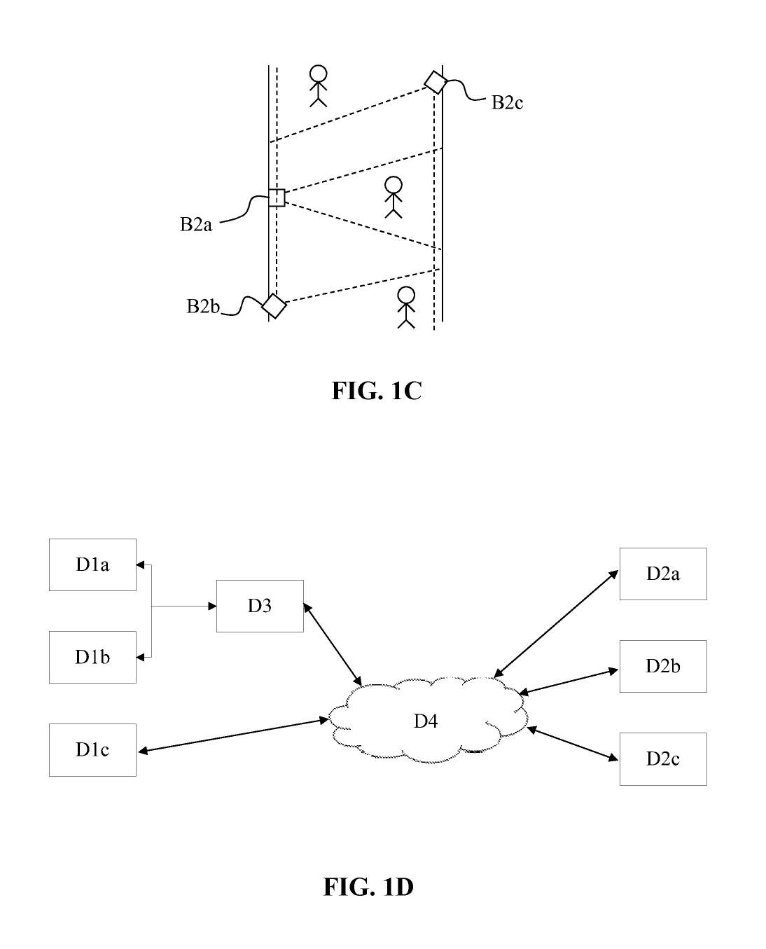

### DETAILED DESCRIPTION OF THE PREFERRED EMBODIMENTS

To achieve the foregoing objectives and effects, the inventors utilize a plurality of shooting module to take dynamic images of a visitor with various kinds of communication protocols and make improvements and modifications to the conventional video-audio outdoor communication device, thus achieving a multi-scene monitoring system and a method for controlling the same of the present invention. Hereinafter, system architecture of the multi-scene monitoring system of the present invention, a method for controlling the multi-scene monitoring system according to a first preferred embodiment of the present invention, a method for controlling the multi-scene monitoring system according to a second preferred embodiment of the present invention, a method for controlling the multi-scene monitoring system according to a third preferred embodiment of the present invention, and a method for controlling the multi-scene monitoring system according to a fourth preferred embodiment of the present invention are described in detail to illustrate the system structure and control methods of the present invention.

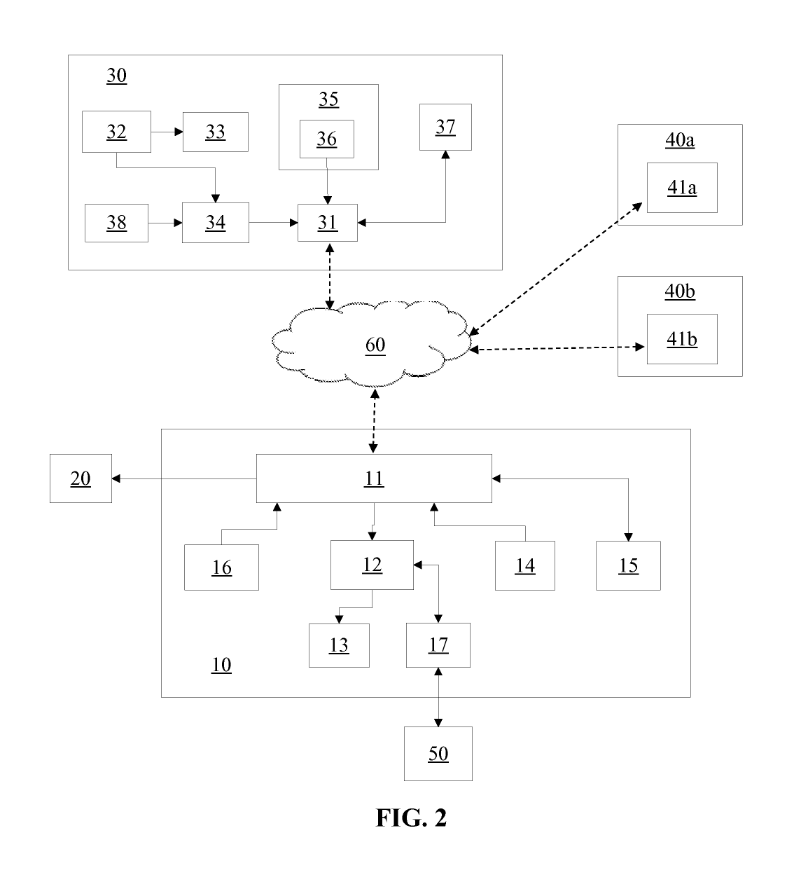

Referring to FIG. 2, which is an architectural diagram of the multi-scene monitoring system of the present invention. The surveillance system includes an internal communication device 10, a warning module 20, a door end operating device 30, and a plurality of external shooting module.

The internal communication device 10 is disposed indoors and includes: a first data processing unit 11 for integrating and transmitting image and audio data and operation information; an image receiving unit 12 being connected with the first data processing unit 11 and obtaining image streams from the first data processing unit 11; an image display 13 being connected with the image receiving unit 12 and displaying the image streams obtained from the image receiving unit 12; an image switching unit 14 being connected with the first data processing unit 11 and sending commands to switch different image streams; a receiving end intercom module 15 being connected with the first data processing unit 11 and for a host to talk with a visitor; an access control unit 16 for the host to unlock the door so as to permit the entrance of the visitor; and an output/input unit 17 connected with the image receiving unit 12 and an external display device 50, wherein the output/input unit 17 and the external display device 50 can transmit the image streams to each other through a wire.

The warning module 20 is disposed indoors. In practical applications, the warning module 20 also can be disposed on the internal communication device 10. The warning module 20 is controlled by the first data processing unit 11 to send out warning messages. The warning module 20 is separately or simultaneously able to send out different forms of warning messages, including sounds, light signals and images.

The door end operating device 30 is disposed outdoors and includes: a second data processing unit 31 for integrating image and audio data and transmitting the data to the first data processing unit 11 through an internet 60; an input unit 32 for the visitor to input a particular number representing the host so as to notify the host through a driving unit 34 and the warning module 20; a display unit 33 for the visitor to obtain the response message of the host; a driving unit 34 being connected with the second data processing unit 31 and provided for the visitor to activate the warning module 20; a sensing unit 38 for receiving particular signals and transmitting the signals to the driving unit 34 and the second data processing unit 31 so as to unlock the door; a door end shooting module 35 including a third data processing unit 36 and taking images of the visitor, wherein the images are transmitted to the second data processing unit 31 by the third data processing unit 36; and a door end intercom module 37 being connected with the second data processing unit 31 and provided for the visitor to talk with the host.

The plurality of external shooting module 40a and 40b are disposed at a particular position outdoors and include a fourth data processing unit 41a and 41b respectively. The images of the visitor taken by the plurality of external shooting module 40a and 40b are transmitted to the internal communication device 10 by the fourth data processing unit 41a and 41b and displayed on the image display 13, and the shooting angles of the external shooting module 40a and 40b and the door end shooting module 35 are different so as to decrease shooting dead spaces.

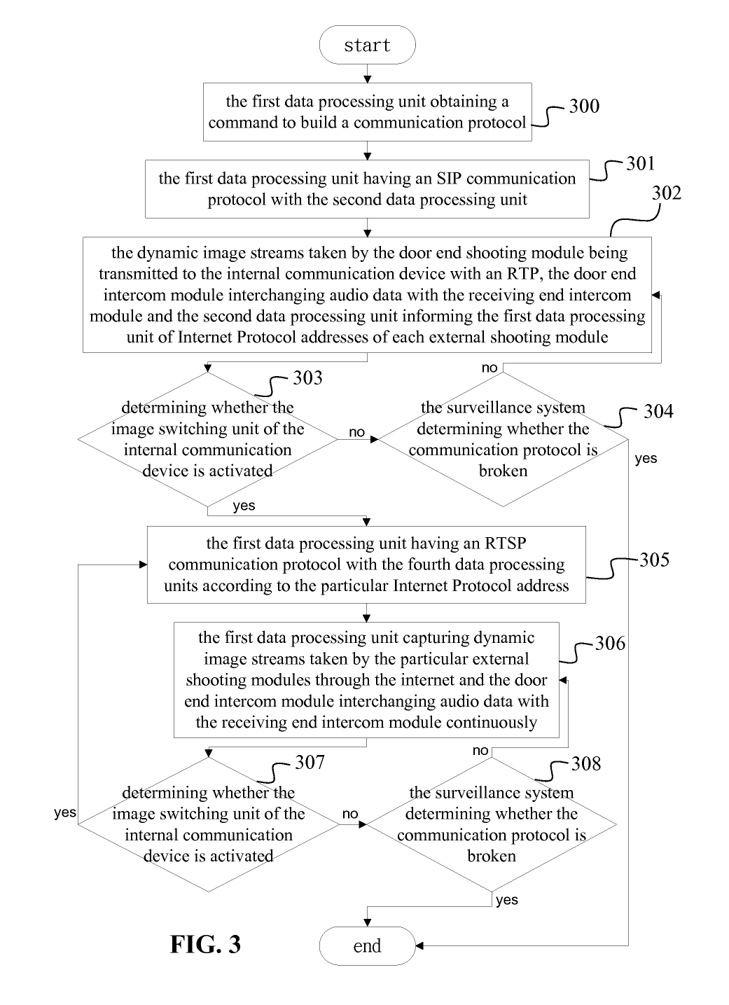

Referring to FIG. 3, which is a flow chart for controlling the multi-scene monitoring system according to the first preferred embodiment of the present invention, and FIG. 2 at the same time, wherein the door end operating device 30 is connected with each external shooting module 40a and 40b to form a group, the first data processing unit 11 capturing dynamic image streams from a particular shooting module 40a and 40b with a RTSP (real time streaming protocol) or a Multicast protocol when an image switching unit 14 is driven. The control method includes the steps of: (step 300) the first data processing unit 11 obtaining a command to build a communication protocol; (step 301) the first data processing unit 11 having an SIP (Session Initiation Protocol) communication protocol with the second data processing unit 31; (step 302) the dynamic image streams taken by the door end shooting module 35 being transmitted to the internal communication device 10 with an RTP (Real Time Transport Protocol), the door end intercom module 37 interchanging audio data with the receiving end intercom module 15 and the second data processing unit 31 informing the first data processing unit 11 of Internet Protocol addresses of each external shooting module 40a and 40b; (step 303) determining whether the image switching unit 14 of the internal communication device 10 is activated, if yes, going to step 305, otherwise, going to step 304; (step 304) the surveillance system determining whether the communication protocol is broken, if yes, ending the method, otherwise, going to step 302; (step 305) the first data processing unit 11 having an RTSP (Real Time Streaming Protocol) communication protocol or a Multicast protocol with the fourth data processing units 41 a or 4 lb according to the particular Internet Protocol address, wherein the first data processing unit 11 is the client end and the fourth data processing units 41a and 41b are the server end in the communication protocols; (step 306) the first data processing unit 11 capturing dynamic image streams taken by the particular external shooting modules 40a or 40b through the internet 60 and the door end intercom module 37 interchanging audio data with the receiving end intercom module 15 continuously; (step 307) determining whether the image switching unit 14 of the internal communication device 10 is activated, if yes, going to step 305, otherwise, going to step 308; and (step 308) the surveillance system determining whether the communication protocol is broken, if yes, ending the method, otherwise, going to step 306.

The surveillance system in the above first preferred embodiment includes a plurality of external shooting modules 40a and 40b, and the user is able to switch dynamic image streams randomly between the door end shooting module 35 and the plurality of external shooting modules 40a and 40b.

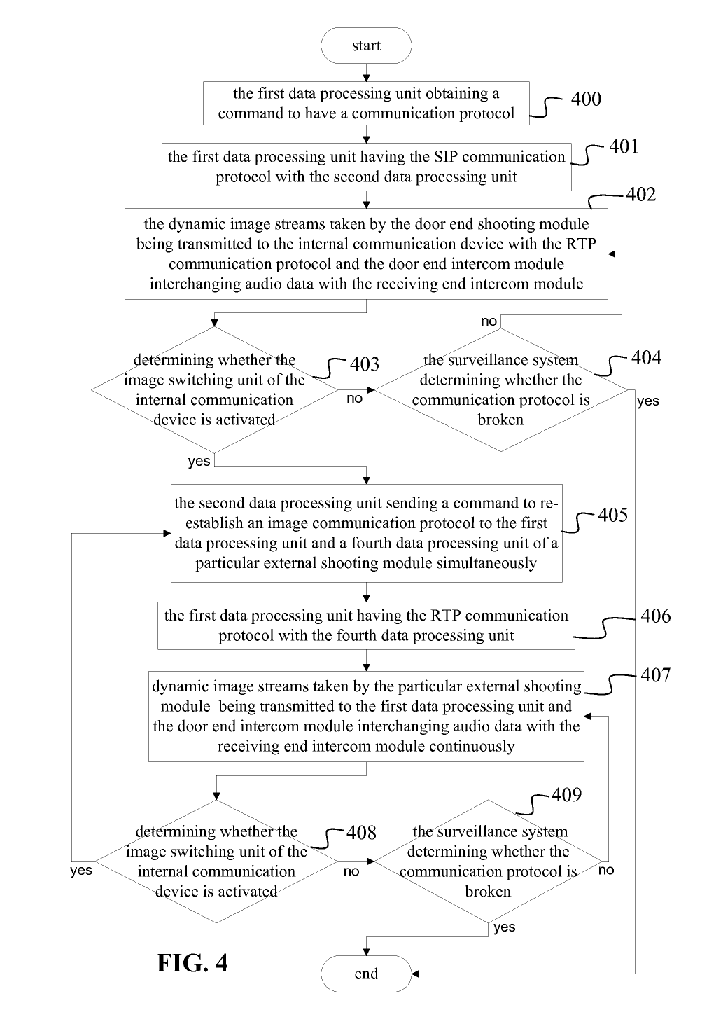

Referring to FIG. 4, which is a flow chart for controlling the multi-scene monitoring system according to the second preferred embodiment of the present invention, and FIG. 2 at the same time, wherein the door end operating device 30 is connected with each external shooting module 40a and 40b to form a group, the second data processing unit 31 sending an SIP reinvite command to the first data processing unit 11 and a fourth data processing unit (such as 41a) of a particular external shooting module (such as 40a) simultaneously when the image switching unit 14 is activated and the particular external shooting module 40a transmits image streams to the internal communication device 10. The control method includes the steps of: (step 400) the first data processing unit 11 obtaining a command to have a communication protocol; (step 401) the first data processing unit 11 having the SIP communication protocol with the second data processing unit 31; (step 402) the dynamic image streams taken by the door end shooting module 35 being transmitted to the internal communication device 10 with the RTP communication protocol and the door end intercom module 37 interchanging audio data with the receiving end intercom module 15; (step 403) determining whether the image switching unit 14 of the internal communication device 10 is activated, if yes, going to step 405, otherwise, going to step 404; (step 404) the surveillance system determining whether the communication protocol is broken, if yes, ending the method, otherwise, going to step 402; (step 405) the second data processing unit 31 sending a command to re-establish an image communication protocol to the first data processing unit 11 and a fourth data processing unit (such as 41a) of a particular external shooting module (such 40a) simultaneously; (step 406) the first data processing unit 11 having the RTP communication protocol with the fourth data processing unit 41a; (step 407) dynamic image streams taken by the particular external shooting module 40a being transmitted to the first data processing unit 11 and the door end intercom module 37 interchanging audio data with the receiving end intercom module 15 continuously; (step 408) determining whether the image switching unit 14 of the internal communication device 10 is activated, if yes, going to step 405, otherwise, going to step 409; and (step 409) the surveillance system determining whether the communication protocol is broken, if yes, ending the method, otherwise, going to step 407.

The surveillance system in the above second preferred embodiment includes a plurality of external shooting modules 40a and 40b, and the user is able to switch dynamic image streams randomly between the door end shooting module 35 and the plurality of external shooting modules 40a and 40b.

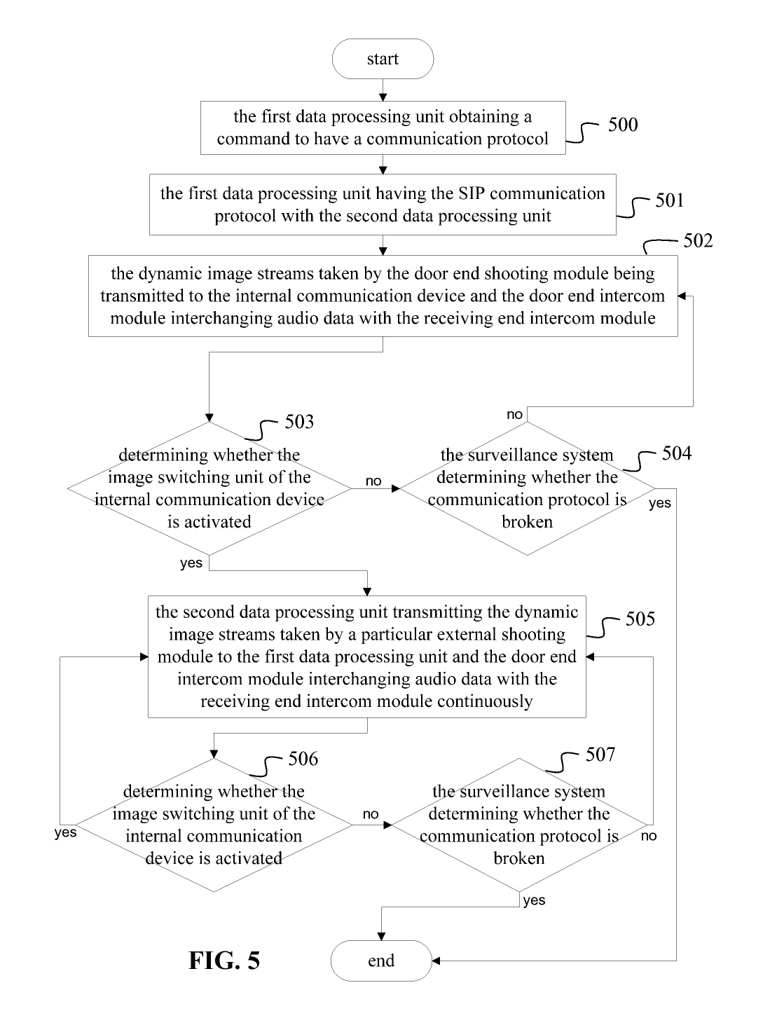

Referring to FIG. 5, which is a flow chart for controlling the multi-scene monitoring system according to the third preferred embodiment of the present invention, and FIG. 2 at the same time, wherein the door end operating device 30 is connected with each external shooting module 40a and 40b to form a group, the switch to the external shooting modules employing multiple RTP streaming, dynamic image streams taken by each external shooting module 40a and 40b being transmitted to the second data processing unit 31 continuously, and the second data processing unit 31 transmitting the dynamic image streams of a particular external shooting module (such as 40a) to the internal communication device 10 when an image switching unit 14 is driven. The control method includes the steps of: (step 500) the first data processing unit 11 obtaining a command to have a communication protocol; (step 501) the first data processing unit 11 having the SIP communication protocol with the second data processing unit 31; (step 502) the dynamic image streams taken by the door end shooting module 35 being transmitted to the internal communication device 10 and the door end intercom module 37 interchanging audio data with the receiving end intercom module 15; (step 503) determining whether the image switching unit 14 of the internal communication device 10 is activated, if yes, going to step 505, otherwise, going to step 504; (step 504) the surveillance system determining whether the communication protocol is broken, if yes, ending the method, otherwise, going to step 502; (step 505) the second data processing unit 31 transmitting the dynamic image streams taken by a particular external shooting module 40a or 40b to the first data processing unit 11 and the door end intercom module 37 interchanging audio data with the receiving end intercom module 15 continuously; (step 506) determining whether the image switching unit 14 of the internal communication device 10 is activated, if yes, going to step 505, otherwise, going to step 507; and (step 507) the surveillance system determining whether the communication protocol is broken, if yes, ending the method, otherwise, going to step 505.

The surveillance system in the above third preferred embodiment includes a plurality of external shooting modules 40a and 40b, and the user is able to switch dynamic image streams randomly between the door end shooting module 35 and the plurality of external shooting modules 40a and 40b.

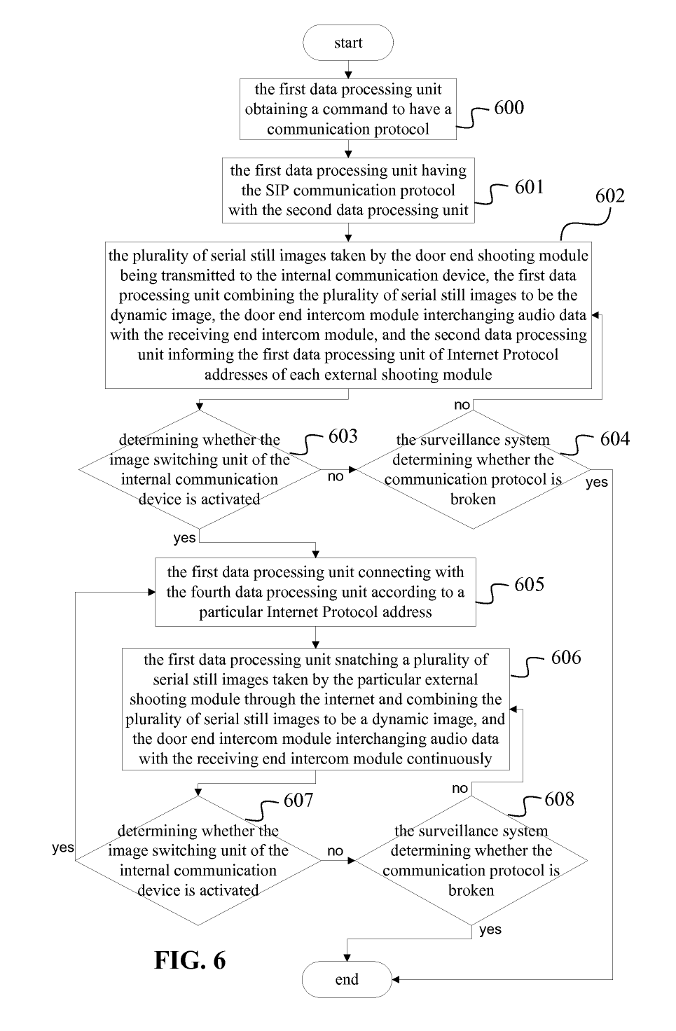

Referring to FIG. 6, which is a flow chart for controlling the multi-scene monitoring system according to the fourth preferred embodiment of the present invention, and FIG. 2 at the same time, wherein the door end operating device 30 is connected with each external shooting module 40a and 40b to form a group, the first data processing unit 11 capturing a plurality of serial still images taken by a particular external shooting module 40a or 40b through the internet 60 and combines the still images to be a dynamic image when the image switching unit 14 is driven. The control method includes the steps of: (step 600) the first data processing unit 11 obtaining a command to have a communication protocol; (step 601) the first data processing unit 11 having the SIP communication protocol with the second data processing unit 31; (step 602) the plurality of serial still images taken by the door end shooting module 35 being transmitted to the internal communication device 10, the first data processing unit 11 combining the plurality of serial still images to be the dynamic image, the door end intercom module 37 interchanging audio data with the receiving end intercom module 15, and the second data processing unit 31 informing the first data processing unit 11 of Internet Protocol addresses of each external shooting module 40a and 40b; (step 603) determining whether the image switching unit 14 of the internal communication device 10 is activated, if yes, going to step 605, otherwise, going to step 604; (step 604) the surveillance system determining whether the communication protocol is broken, if yes, ending the method, otherwise, going to step 602; (step 605) the first data processing unit 11 connecting with the fourth data processing unit 41a or 41b according to a particular Internet Protocol address; (step 606) the first data processing unit 11 snatching a plurality of serial still images taken by the particular external shooting module 40a or 40b through the internet 60 and combining the plurality of serial still images to be a dynamic image, and the door end intercom module 37 interchanging audio data with the receiving end intercom module 15 continuously; (step 607) determining whether the image switching unit 14 of the internal communication device 10 is activated, if yes, going to step 605, otherwise, going to step 608; (step 608) the surveillance system determining whether the communication protocol is broken, if yes, ending the method, otherwise, going to step 606.

The surveillance system in the above fourth preferred embodiment includes a plurality of external shooting modules 40a and 40b, and the user is able to switch dynamic image streams randomly between the door end shooting module 35 and the plurality of external shooting modules 40a and 40b.

In the above first, second, third, and fourth preferred embodiments, the surveillance system permits the user to achieve two purposes. The first purpose is that the surveillance system will drive the warning module 20 to notify the host of the visitor information when the visitor operates the inputting unit 32 and the driving unit 34 of the door end operating device 30, the host can starts the shooting modules to obtain the dynamic images of the visitor, and the host can switch different shooting modules to obtain dynamic images with different angles or scenes so as to decrease shooting dead space and increase home safety. The second purpose is that the user can start shooting modules at any time to obtain the dynamic images taken by a particular shooting module, and the user can switch different shooting modules to confirm the security states of all shooting angles or scenes so as to increase home safety.

By the detailed description of the overall structure and technical content of the present invention, the following advantages of the present invention can be derived:

1. The system of the present invention employs the internet 60 as a medium, thus the installation and maintenance costs can be decreased without spending a lot of money, time and manpower to install concrete wires.
2. The present invention provides the user to switch different shooting angles or scenes, and the control method of switch can be achieved by at least four approaches, thus the architecture of the present invention is very flexible and variable.
3. The present invention provides the user to switch different shooting angles and scenes, wherein the user not only can confirm the status of the visitor with different shooting angles or scenes, but also can start and switch shooting modules without visiting by a visitor to monitor the environment of the house and increase the home safety.

It should be understood that the embodiments of the present invention described herein are merely illustrative of the technical concepts and features of the present invention and are not meant to limit the scope of the invention. Those skilled in the art, after reading the present disclosure, will know how to practice the invention. Various variations or modifications can be made without departing from the spirit of the invention. All such equivalent variations and modifications are intended to be included within the scope of the invention.

As a result of continued thinking about the invention and modifications, the inventors finally work out the designs of the present invention that has many advantages as described above. The present invention meets the requirements for an invention patent, and the application for a patent is duly filed accordingly. It is expected that the invention could be examined at an early date and granted so as to protect the rights of the inventors.

What is claimed is:

1. A multi-scene monitoring system comprising:
an internal communication device being disposed indoors and comprising:
a first data processing unit for integrating and transmitting image and audio data and operation information;
an image receiving unit being connected with the first data processing unit and obtaining image streams from the first data processing unit;
an image display being connected with the image receiving unit and displaying the image streams obtained from the image receiving unit;
an image switching unit being connected with the first data processing unit and sending commands to switch different image streams; and
a receiving end intercom module being connected with the first data processing unit and for a host to talk with a visitor;
a warning module being disposed indoors and controlled by the first data processing unit to send out warning messages;
a door end operating device being disposed outdoors and comprising:
a second data processing unit for integrating image and audio data and transmitting the data to the first data processing unit through an internet;
a driving unit being connected with the second data processing unit and provided for the visitor to activate the warning module;
a door end shooting module comprising a third data processing unit and taking images of the visitor, wherein the images are transmitted to the second data processing unit by the third data processing unit; and
a door end intercom module being connected with the second data processing unit and provided for the visitor to talk with the host; and
at least one external shooting module being disposed at a particular position outdoors and comprising a fourth data processing unit, wherein the images of the visitor taken by the external shooting module are transmitted to the second data processing unit by the fourth data processing unit, and wherein the shooting angles of the external shooting module and the door end shooting module are different so as to decrease shooting dead spaces.

2. The multi-scene monitoring system according to claim 1, wherein the door end operating device further comprises an input unit for the visitor to input a particular number representing the host so as to notify the host through the driving unit and the warning module.

3. The multi-scene monitoring system according to claim 1, wherein the door end operating device further comprises a display unit for the visitor to obtain the response message of the host.

4. The multi-scene monitoring system according to claim 1, wherein the warning module is disposed on the internal communication device.

5. The multi-scene monitoring system according to claim 1, wherein the warning module is separately or simultaneously able to send out the following message group consisted of: sounds, light signals and images.

6. The multi-scene monitoring system according to claim 1, wherein the door end operating device further comprises a sensing unit for receiving particular signals and transmitting the signals to the driving unit and the second data processing unit so as to unlock the door.

7. The multi-scene monitoring system according to claim 1, wherein the internal communication device further comprises an access control unit for the host to unlock the door so as to permit the entrance of the visitor.

8. The multi-scene monitoring system according to claim 1, wherein the internal communication device further comprises an output/input unit connected with the image receiving unit and an external display device, and wherein the output/input unit and the external display device can transmit the image streams to each other through a wire.

9. A method for controlling a multi-scene monitoring system, wherein a door end operating device is connected with each external shooting module to form a group, a first data processing unit of an internal communication device capturing dynamic image streams from a particular shooting module with a RTSP (real time streaming protocol) or a Multicast protocol when an image switching unit is driven, comprising the steps of:
(1) the first data processing unit obtaining a command to build a communication protocol;
(2) the first data processing unit having the communication protocol with a second data processing unit of a door end operating device;
(3) the dynamic image streams taken by a door end shooting module being transmitted to the internal communication device, a door end intercom module interchanging audio data with a receiving end intercom module and the second data processing unit informing the first data processing unit of Internet Protocol addresses of each external shooting module;
(4) an image switching unit of the internal communication device being activated;
(5) the first data processing unit having a communication protocol with a fourth data processing unit of a particular external shooting module according to a particular Internet Protocol address; and
(6) the first data processing unit capturing dynamic image streams taken by the particular external shooting module through an internet and the door end intercom module interchanging audio data with the receiving end intercom module continuously.

10. The method for controlling the multi-scene monitoring system according to claim 9, wherein the surveillance system further comprises a plurality of external shooting modules and a user is able to switch dynamic image streams randomly between the door end shooting module and the plurality of external shooting modules.

11. A method for controlling a multi-scene monitoring system, wherein a door end operating device is connected with each external shooting module to form a group, a second data processing unit of a door end operating device sending an SIP reinvite command to a first data processing unit of an internal communication device and a fourth data processing unit of a particular external shooting module simultaneously when an image switching unit is activated and the particular external shooting module transmits image streams to the internal communication device, comprising the steps of:
(1) the first data processing unit obtaining a command to have a communication protocol;
(2) the first data processing unit having the communication protocol with the second data processing unit;
(3) the dynamic image streams taken by a door end shooting module being transmitted to the internal communication device and a door end intercom module interchanging audio data with a receiving end intercom module;
(4) an image switching unit of the internal communication device being activated;
(5) the second data processing unit sending a command to re-establish an image communication protocol to the first data processing unit and the fourth data processing unit simultaneously;
(6) the first data processing unit having a communication protocol with the fourth data processing unit; and
(7) dynamic image streams taken by the particular external shooting module being transmitted to the first data processing unit and the door end intercom module interchanging audio data with the receiving end intercom module continuously.

12. The method for controlling the multi-scene monitoring system according to claim 11, wherein the surveillance system further comprises a plurality of external shooting modules and the user is able to switch dynamic image streams randomly between the door end shooting module and the plurality of external shooting modules.

13. A method for controlling a multi-scene monitoring system, wherein a door end operating device is connected with each external shooting module to form a group, the switch to the external shooting modules employing multiple RTP streaming, dynamic image streams taken by each external shooting module being transmitted to a second data processing unit of a door end operating device continuously, and the second data processing unit transmitting the dynamic image streams of a particular external shooting module to an internal communication device when an image switching unit is driven, comprising the steps of:
(1) a first data processing unit of the internal communication device obtaining a command to have a communication protocol;
(2) the first data processing unit having the communication protocol with the second data processing unit;
(3) the dynamic image streams taken by a door end shooting module being transmitted to the internal communication device and a door end intercom module interchanging audio data with a receiving end intercom module;
(4) an image switching unit of the internal communication device being activated; and
(5) the second data processing unit transmitting the dynamic image streams taken by a particular external shooting module to the first data processing unit and the door end intercom module interchanging audio data with the receiving end intercom module continuously.

14. The method for controlling the multi-scene monitoring system according to claim 13, wherein the surveillance system further comprises a plurality of external shooting modules and the user is able to switch dynamic image streams randomly between the door end shooting module and the plurality of external shooting modules.

15. A method for controlling a multi-scene monitoring system, wherein a door end operating device is connected with each external shooting module to form a group, a first data processing unit of an internal communication device capturing a plurality of serial still images taken by a particular external shooting module through an internet and combines the still images to be a dynamic image when an image switching unit is driven, comprising the steps of:
(1) the first data processing unit obtaining a command to have a communication protocol;
(2) the first data processing unit having the communication protocol with a second data processing unit of a door end operating device;
(3) the plurality of serial still images taken by a door end shooting module being transmitted to the internal communication device, the first data processing unit combining the plurality of serial still images to be the dynamic image, a door end intercom module interchanging audio data with a receiving end intercom module, and the second data processing unit informing the first data processing unit of Internet Protocol addresses of each external shooting module;
(4) an image switching unit of the internal communication device being activated;
(5) the first data processing unit connecting with a fourth data processing unit of a particular external shooting module according to a particular Internet Protocol address; and
(6) the first data processing unit snatching a plurality of serial still images taken by the particular external shooting module through an internet and combining the plurality of serial still images to be a dynamic image, and the door end intercom module interchanging audio data with the receiving end intercom module continuously.

16. The method for controlling the multi-scene monitoring system according to claim 15, wherein the surveillance system further comprises a plurality of external shooting modules and the user is able to switch dynamic image streams randomly between the door end shooting module and the plurality of external shooting modules.
